(19) United States
(12) Patent Application Publication
(10) Pub. No.: US 2011/0306426 A1
(43) Pub. Date: Dec. 15, 2011

(54) Activity Participation Based On User Intent

(75) Inventors: Christopher Michael Novak, Redmond, WA (US); Stephen Paul Dolan, Redmond, WA (US)

(73) Assignee: MICROSOFT CORPORATION, Redmond, WA (US)

(21) Appl. No.: 12/797,906

(22) Filed: Jun. 10, 2010

(51) Int. Cl. A63F 13/12; G06F 15/16

(52) U.S. Cl. 463/42; 709/204

(57) ABSTRACT

A method for enabling a user to participate in an activity in a processing device based on user intent is provided. The method includes receiving a wish list of intents from a user on a processing device. The wish list of intents identifies user intent to participate in one or more activities in processing device. A matching list of intents is generated for the user based on the wish list of intents. The matching list of intents includes at least one activity identified by other users such as users in the user's friends list that match an intent in the wish list of intents specified by the user. The activities may include one or more multiplayer games in the gaming system. A selection of one or more other users in the matching list of intents is received from the user. An activity trigger notification associated with the activity may be provided to the user and the other users based on the selection.

### BACKGROUND

The console and personal computer-based video game experience has evolved from one in which an isolated gaming experience was provided into one in which users on a variety of processing devices such as personal computers and mobile devices can interact with each other to share a common game experience. One example of a system that enables users to communicate with each other is Microsoft's Xbox 360 Live® online game service. Using such systems, users are provided with a rich interactive experience which may be shared in real time between friends and other gamers. For example, users can track their own and their friends' progress through different applications maintained by the online game service. In addition, users can track which of their friends are currently participating or scheduled to participate in an online application, such as an online program game.

### SUMMARY

Disclosed herein is a method and system by which users on a variety of processing devices can participate in one or more activities based on user intent. Activities may include game related activities such as, for example, single player games or multiplayer games in the processing device or non-game related activities such as a movie, a television show or a chat session in the processing device. A user specifies a wish list of intents to specify participation in one or more activities, via a user interface in a processing device. A user may also specify a wish list of intents via various applications executing in the user's processing device such as the user's email application, or via Facebook®.

In an embodiment, the processing device includes a gaming and media console. The processing device may also include a personal computer, or a mobile device, such as, for example, a cell phone, a web-enabled smart phone, a personal digital assistant, a palmtop computer or a laptop computer. The user's wish list of intents is displayed via a user interface on the user's processing device. The user's wish list of intents may also be published across various applications executing in the user's processing device. The wish list of intents is communicated to other users, such as the user's friends and a matching list of intents is generated for each user based on the wish list of intents. The matching list of intents is displayed on a user interface in the user's processing device. The matching list of intents displays a list of the users who also intend to participate in at least one online activity specified by the user in the user's wish list of intents. A user may invite other users to participate in a particular online activity based on the matching list of intents.

In an embodiment, a method for enabling a user to participate in an activity in a processing device based on user intent is disclosed. The method includes receiving a wish list of intents from a user on a processing device. The wish list of intents identifies user intent to participate in one or more activities in the processing device. A matching list of intents is generated for the user based on the wish list of intents. The matching list of intents includes at least one activity identified by other users such as users in the user's friends list that match an intent in the wish list of intents specified by the user. The activities may include game related activities such as, for example, single player games or multiplayer games in the processing device or non-game related activities in the processing device. A selection of one or more other users in the matching list of intents is received from the user. An activity trigger notification associated with the activity is provided to the user and the other users based on the selection.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1A is an isometric view of an exemplary gaming and media system.

FIG. 1B is an exemplary functional block diagram of components of the gaming and media system shown in FIG. 1.

FIG. 1C illustrates another example embodiment of the gaming and media system shown in FIGS. 1-2.

FIG. 2 is a block diagram of a mobile device.

FIG. 3 is a block diagram of an exemplary operating environment for enabling users to participate in a multiplayer game based on user intent.

FIG. 4 illustrates an exemplary set of operations performed by the disclosed technology to enable a user to participate in a multiplayer game based on user intent.

FIG. 5 illustrates an exemplary set of operations performed by the multimedia gaming service in the gaming and media system shown in FIG. 3 to enable a user to participate in a multiplayer game based on user intent.

FIG. 6 illustrates an exemplary user interface screen for enabling a user to specify participation in a multiplayer game based on user intent.

FIG. 7 illustrates an exemplary user interface screen that displays a user's wish list of intents.

FIG. 8 illustrates an exemplary user interface screen that displays a user's matching list of intents.

FIG. 9 is an exemplary user interface screen that allows a user to invite other users to participate in a multiplayer game based on user intent.

FIGS. 10-12 illustrate a target recognition and analysis system as an exemplary processing device for implementing the operations of the disclosed technology.

### DETAILED DESCRIPTION

Technology is disclosed which improves a gaming experience by enabling users to participate in activities based on their actual interests rather than what they may be doing at a given time. A user's current participation in a particular activity may not always be reflective of the user's actual interest in participating in the activity. A user may be engaged in an alternate activity, such as, for example, watching a movie, if the user does not find other available players to play a particular game related activity that the user wishes to participate in. Or, the user may be engaged in a game related activity until other users become available to participate in a game related activity that the user actually wishes to participate in. Or, for example, a user may be engaged in an alternate activity and may not wish to invite another user to participate in a particular activity, if the user does not wish to disturb the other user by sending multiple messages to the user.

In an embodiment, the disclosed technology allows a user to specify a wish list of intents, via a user interface, in a processing device such as a gaming and media console, a personal computer, or a mobile device. The wish list of intents identifies user intent to participate in one or more activities in the processing device. A matching list of intents is generated for the user, based on the user's wish list of intents. The matching list of intents displays to each user, a list of the users who intend to participate in at least one activity, such as, for example, one or more online multiplayer games specified in the user's wish list of intents. A user may invite other users to participate in the activity based on the matching list of intents.

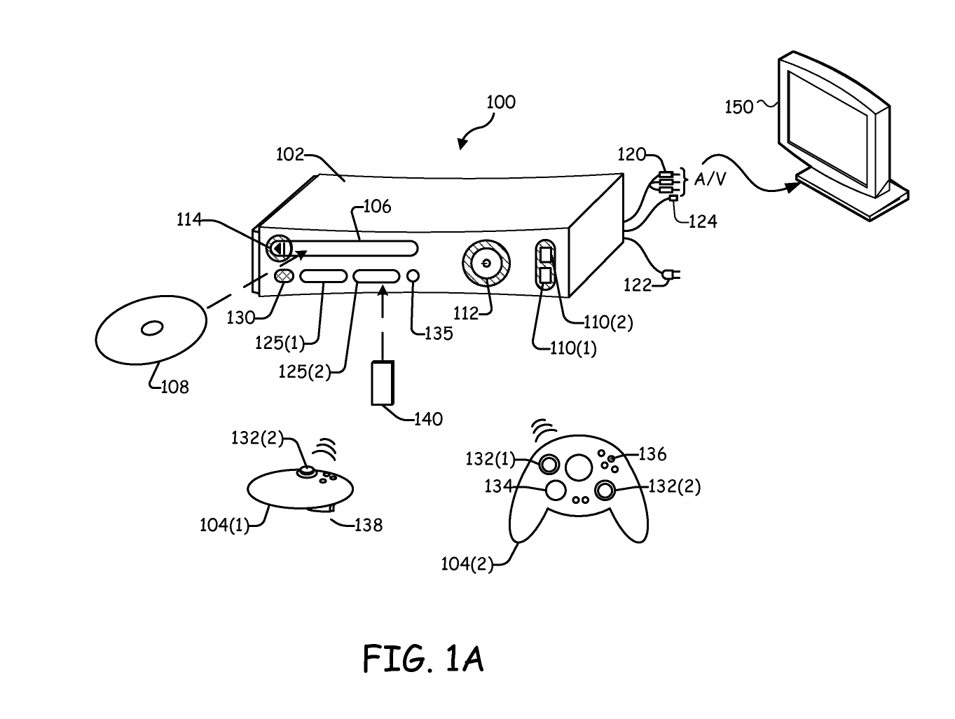

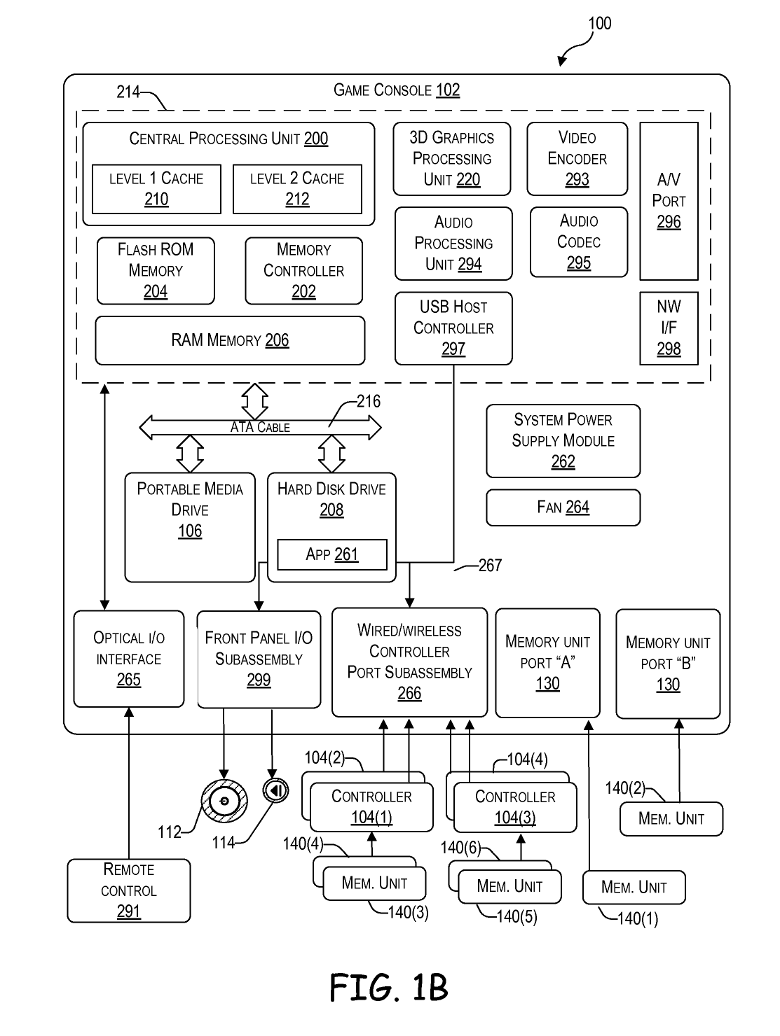

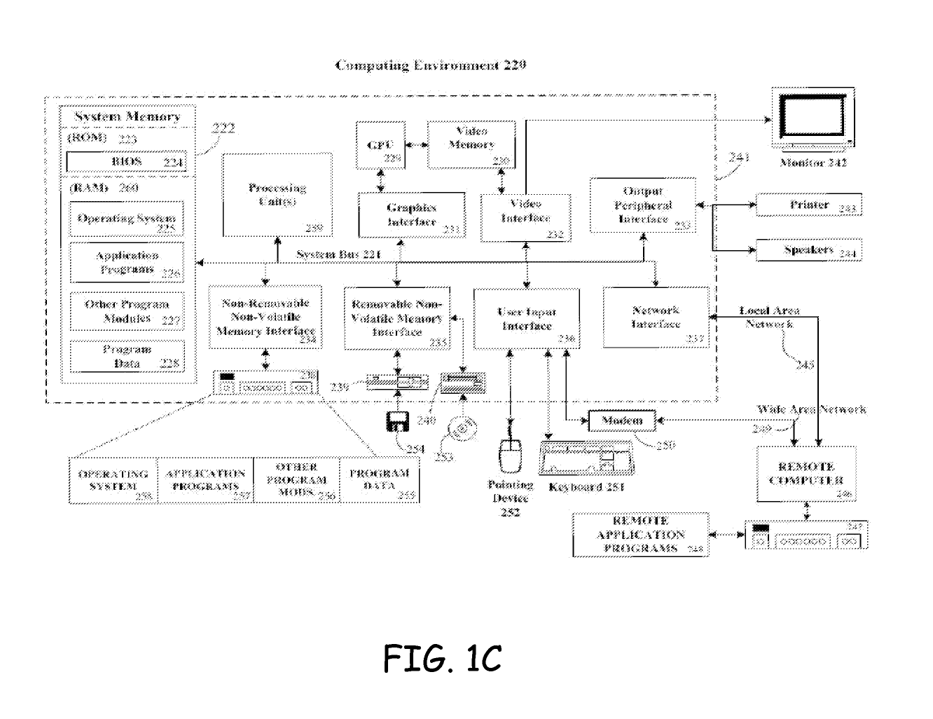

FIG. 1A shows a gaming and media system as an exemplary processing device for implementing the operations of the disclosed technology. As shown in FIG. 1A, gaming and media system 100 includes a game and media console (hereinafter “console”) 102. In general, console 102 is one type of computing system, as will be further described below. Console 102 is configured to accommodate one or more wireless controllers, as represented by controllers 104(1) and 104(2). Console 102 is equipped with an internal hard disk drive (not shown) and a portable media drive 106 that support various forms of portable storage media, as represented by optical storage disc 108. Examples of suitable portable storage media include DVD, CD-ROM, game discs, and so forth. Console 102 also includes two memory unit card receptacles 125(1) and 125(2), for receiving removable flash-type memory units 140. A command button 135 on console 102 enables and disables wireless peripheral support.

As depicted in FIG. 1A, console 102 also includes an optical port 130 for communicating wirelessly with one or more devices and two USB (Universal Serial Bus) ports 110(1) and 110(2) to support a wired connection for additional controllers, or other peripherals. In some implementations, the number and arrangement of additional ports may be modified. A power button 112 and an eject button 114 are also positioned on the front face of game console 102. Power button 112 is selected to apply power to the game console, and can also provide access to other features and controls, and eject button 114 alternately opens and closes the tray of a portable media drive 106 to enable insertion and extraction of a storage disc 108.

Console 102 connects to a television or other display (such as monitor 150) via A/V interfacing cables 120. In one implementation, console 102 is equipped with a dedicated A/V port (not shown) configured for content-secured digital communication using A/V cables 120 (e.g., A/V cables suitable for coupling to a High Definition Multimedia Interface “HDMI” port on a high definition monitor 150 or other display device). A power cable 122 provides power to the game console. Console 102 may be further configured with broadband capabilities, as represented by a cable or modem connector 124 to facilitate access to a network, such as the Internet. The broadband capabilities can also be provided wirelessly, through a broadband network such as a wireless fidelity (Wi-Fi) network.

Each controller 104 is coupled to console 102 via a wired or wireless interface. In the illustrated implementation, the controllers 104 are USB-compatible and are coupled to console 102 via a wireless or USB port 110. Console 102 may be equipped with any of a wide variety of user interaction mechanisms. In an example illustrated in FIG. 1A, each controller 104 is equipped with two thumbsticks 132(1) and 132(2), a D-pad 134, buttons 136, and two triggers 138. These controllers are merely representative, and other known gaming controllers may be substituted for, or added to, those shown in FIG. 1A.

In one implementation, a memory unit (MU) 140 may also be inserted into controller 104 to provide additional and portable storage. Portable MUs enable users to store game parameters for use when playing on other consoles. In this implementation, each controller is configured to accommodate two MUs 140, although more or less than two MUs may also be employed.

Gaming and media system 100 is generally configured for playing games stored on a memory medium, as well as for downloading and playing games, and reproducing pre-recorded music and videos, from both electronic and hard media sources. With the different storage offerings, titles can be played from the hard disk drive, from an optical disk media (e.g., 108), from an online source, or from MU 140.

During operation, console 102 is configured to receive input from controllers 104 and display information on display 150. For example, console 102 can display a user interface on display 150 to allow a user to participate in a multiplayer game using controller 104 based on user intent, as discussed below.

FIG. 1B is a functional block diagram of gaming and media system 100 and shows functional components of the gaming and media system 100 in more detail. Console 102 has a central processing unit (CPU) 200, and a memory controller 202 that facilitates processor access to various types of memory, including a flash Read Only Memory (ROM) 204, a Random Access Memory (RAM) 206, a hard disk drive 208, and portable media drive 106. In one implementation, CPU 200 includes a level 1 cache 210 and a level 2 cache 212, to temporarily store data and hence reduce the number of memory access cycles made to the hard drive 208, thereby improving processing speed and throughput.

CPU 200, memory controller 202, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 200, memory controller 202, ROM 204, and RAM 206 are integrated onto a common module 214. In this implementation, ROM 204 is configured as a flash ROM that is connected to memory controller 202 via a PCI bus and a ROM bus (neither of which are shown). RAM 206 is configured as multiple Double Data Rate Synchronous Dynamic RAM (DDR SDRAM) modules that are independently controlled by memory controller 202 via separate buses (not shown). Hard disk drive 208 and portable media drive 106 are shown connected to the memory controller 202 via the PCI bus and an AT Attachment (ATA) bus 216. However, in other implementations, dedicated data bus structures of different types can also be applied in the alternative.

A graphics processing unit 220 and a video encoder 293 form a video processing pipeline for high speed and high resolution (e.g., High Definition) graphics processing. Data are carried from graphics processing unit 220 to video encoder 293 via a digital video bus (not shown). An audio processing unit 294 and an audio codec (coder/decoder) 295 form a corresponding audio processing pipeline for multi-channel audio processing of various digital audio formats. Audio data are carried between audio processing unit 294 and audio codec 295 via a communication link (not shown). The video and audio processing pipelines output data to an A/V (audio/video) port 296 for transmission to a television or other display. In the illustrated implementation, video and audio processing components are mounted on module 214.

FIG. 1B shows module 214 including a USB host controller 297 and a network interface 298. USB host controller 297 is shown in communication with CPU 200 and memory controller 202 via a bus (e.g., PCI bus) and serves as host for peripheral controllers 104(1)-104(4). Network interface 298 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 1B, console 102 includes a controller support subassembly 266 for supporting four controllers 104(1)-104(4). The controller support subassembly 266 includes any hardware and software components needed to support wired and wireless operation with an external control device, such as for example, a media and game controller. A front panel I/O subassembly 299 supports the multiple functionalities of power button 112, the eject button 114, as well as any LEDs (light emitting diodes) or other indicators exposed on the outer surface of console 102. Subassemblies 266 and 299 are in communication with module 214 via one or more cable assemblies 267. In other implementations, console 102 can include additional controller subassemblies. The illustrated implementation also shows an optical I/O interface 265 that is configured to send and receive signals that can be communicated to module 214.

MUs 140(1) and 140(2) are illustrated as being connectable to MU ports “A” 130(1) and “B” 130(2) respectively. Additional MUs (e.g., MUs 140(3)-140(6)) are illustrated as being connectable to controllers 104(1) and 104(3), i.e., two MUs for each controller. Controllers 104(2) and 104(4) can also be configured to receive MUs (not shown). Each MU 140 offers additional storage on which games, game parameters, and other data may be stored. In some implementations, the other data can include any of a digital game component, an executable gaming application, an instruction set for expanding a gaming application, and a media file. When inserted into console 102 or a controller, MU 140 can be accessed by memory controller 202. A system power supply module 262 provides power to the components of gaming system 100. A fan 264 cools the circuitry within console 102.

An application 261 comprising machine instructions is stored on hard disk drive 208. When console 102 is powered on, various portions of application 261 are loaded into RAM 206, and/or caches 210 and 212, for execution on CPU 200, wherein application 261 is one such example. Various applications can be stored on hard disk drive 208 for execution on CPU 200.

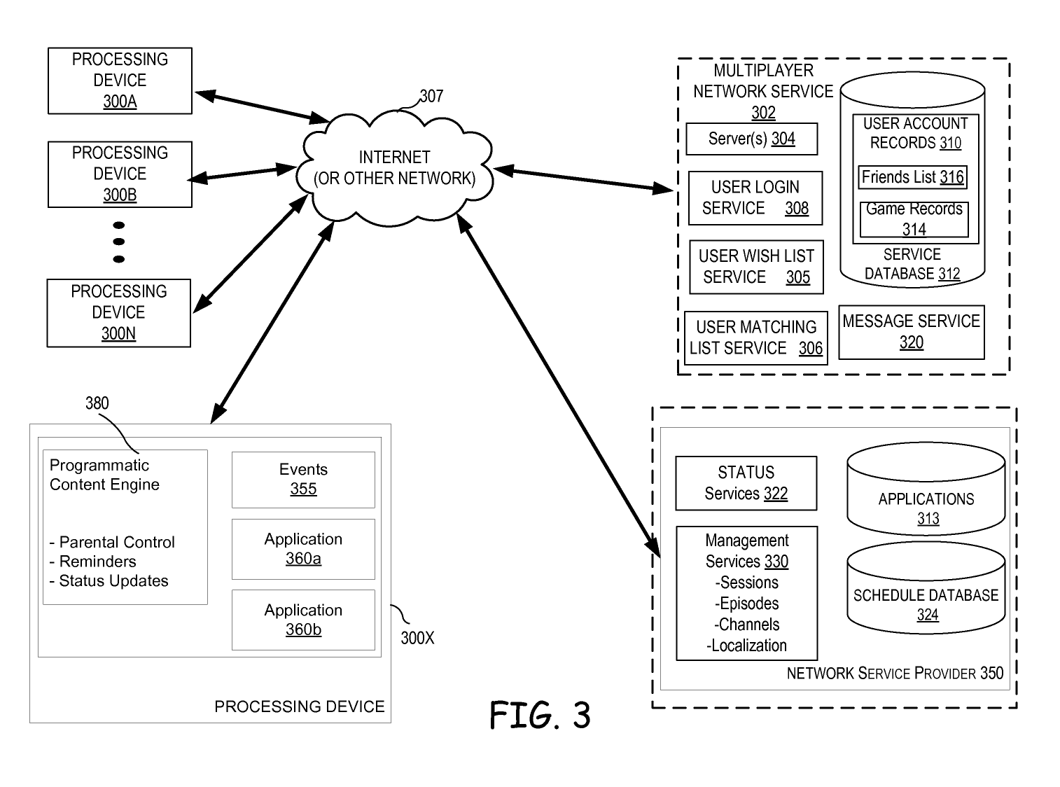

Gaming and media system 100 may be operated as a standalone system by simply connecting the system to monitor 150 (FIG. 1A), a television, a video projector, or other display device. In this standalone mode, gaming and media system 100 enables one or more players to play games, or enjoy digital media, e.g., by watching movies, or listening to music. However, with the integration of broadband connectivity made available through network interface 298, gaming and media system 100 may further be operated as a participant in a larger network gaming community, as discussed in connection with FIG. 3.

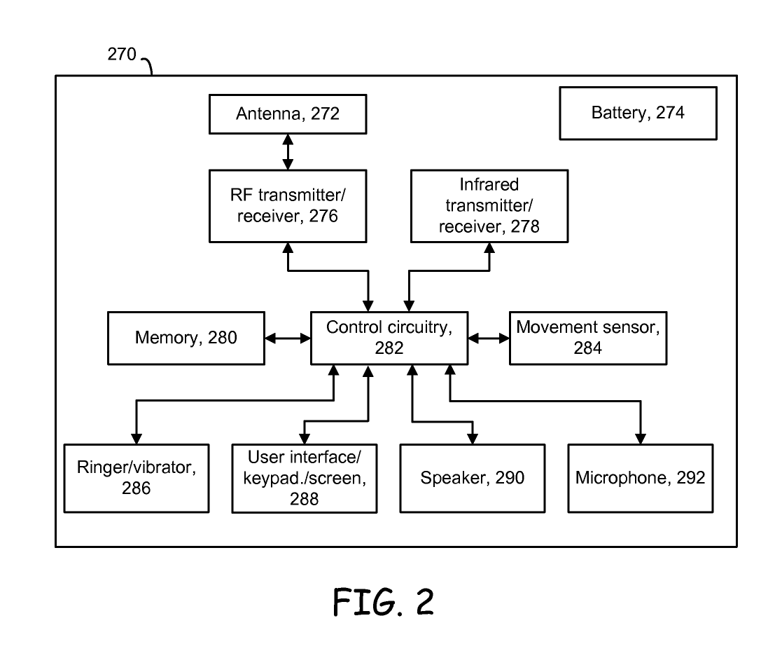

FIG. 1C illustrates another example embodiment of the gaming and media system shown in FIGS. 1A and 1B. In FIG. 1C, the gaming and media system comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as ROM 223 and RAM 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 2A illustrates operating system 225, application programs 226, other program modules 227, and program data 228.

The computer 241 may also include other removable/non-removable, volatile/nonvolatile computer storage media. By way of example only, FIG. 1C illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 1C, provide storage of computer readable instructions, data structures, program modules and other data for the computer 241. In FIG. 1C, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and a pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 26, 28 and capture device 20 may define additional input devices for the console 100. A monitor 242 or other type of display device is also connected to the system bus 221 via an interface, such as a video interface 232. In addition to the monitor, computers may also include other peripheral output devices such as speakers 244 and printer 243, which may be connected through an output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 2A. The logical connections depicted in FIG. 1C include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 1C illustrates remote application programs 248 as residing on memory device 247. It will be appreciated that the network connections shown are exemplary and other means of establishing a communications link between the computers may be used.

The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments, the various depicted computing elements may include circuitry configured to instantiate specific aspects of the present disclosure. For example, the term circuitry used in the disclosure can include specialized hardware components configured to perform function(s) by firmware or switches. In other example embodiments, the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

FIG. 2 shows a mobile device as an exemplary processing device for implementing the operations of the disclosed technology. The mobile device 270 may include, but is not limited to, a cell phone, web-enabled smart phone, personal digital assistant, palmtop computer, laptop computer or any similar device which communicates via wireless signals. As shown in FIG. 2, the block diagram of a mobile device 270 may include control circuitry 282 that can include one or more microprocessors, and storage or memory 280 (e.g., non-volatile memory such as ROM and volatile memory such as RAM) which stores processor-readable code which is executed by one or more processors of the control circuitry 282 to implement the functionality described herein. One or more application programs may be loaded into memory 280, such as phone dialer programs, e-mail programs, PIM (personal information management) programs, internet browser applications, video game applications and so forth.

The control circuitry 282 also communicates with RF transmit/receive circuitry 276 which in turn is coupled to an antenna 272, with an infrared transmitted/receiver 278, and with a movement sensor 284 such as an accelerometer. Accelerometers have been incorporated into mobile devices to enable such applications as intelligent UIs that let users input commands through gestures, indoor GPS functionality which calculates the movement and direction of the mobile device after contact is broken with a GPS satellite, and to detect the orientation of the device and automatically change the display from portrait to landscape when the mobile device is rotated. An accelerometer can be provided, e.g., by a micro-electromechanical system (MEMS) which is built onto a semiconductor chip. Acceleration direction, as well as orientation, vibration and shock can be sensed. The control circuitry 282 may also communicate with a ringer/vibrator 286, a UI keypad/screen 288, a speaker 290, and a microphone 292.

The control circuitry 282 controls transmission and reception of wireless signals. During a transmission mode, the control circuitry 282 provides a voice signal from microphone 292, or other data signal, to the transmit/receive circuitry 276. The transmit/receive circuitry 276 transmits the signal to a remote station (e.g., a fixed station, operator, other cellular phones, etc.) for communication through the antenna 272. The ringer/vibrator 286 is used to signal an incoming call, text message, calendar reminder, alarm clock reminder, or other notification to the user. The ringer/vibrator 286 can emit one or more ring tones which are selected by the user and/or tactile vibrations. During a receiving mode, the transmit/receive circuitry 276 receives a voice or other data signal from a remote station through the antenna 272. A received voice signal is provided to the speaker 290 while other received data signals are also processed appropriately.

FIG. 3 is a block diagram of an environment for performing the operations of disclosed technology. In one example, multiple processing devices 300A-300X are coupled to a network 307 and can communicate with a multiplayer network service 302 having one or more server(s) 304 via network 307. The processing devices 300A-300X may include a gaming and media console, a personal computer, or one or more mobile devices such as, for example, a cell phone, a web-enabled smart phone, a personal digital assistant, a palmtop computer or a laptop computer. Also present and coupled to the network is a network service provider 350. In one embodiment, network 307 comprises the Internet, though other networks such as LAN or WAN are contemplated. The server(s) 304 also includes a communication component capable of receiving information from and transmitting information to processing devices 300A-X and provides a collection of services that applications running on processing devices 300A-X may invoke and utilize. For example, the server(s) 304 in the multiplayer network service 302 may manage a plurality of multiplayer activities concurrently by aggregating events from users executing one or more applications on the processing devices 300A-X. The multiplayer network service 302 and the network service provider 350 may be combined and offered by a single service provider and/or on a single server. Alternatively, the service providers may be different entities. In another embodiment, the network service provider 350 may be provided as a product in the form of hardware and software included on a non-volatile storage medium.

Processing devices 300A-X may invoke user login service 308, which is used to authenticate a user on processing devices 300A-X. During login, login service 308 obtains a gamer tag (a unique identifier associated with the user) and a password from the user as well as an identifier that uniquely identifies the processing device that the user is using and a network path to the processing device. The gamer tag and password are authenticated by comparing them to user account records 310 in a database 312, which may be located on the same server as user login service 308 or may be distributed on a different server or a collection of different servers. Once authenticated, user login service 308 stores the device identifier and the network path in user account records 310 so that messages and information may be sent to the processing device.

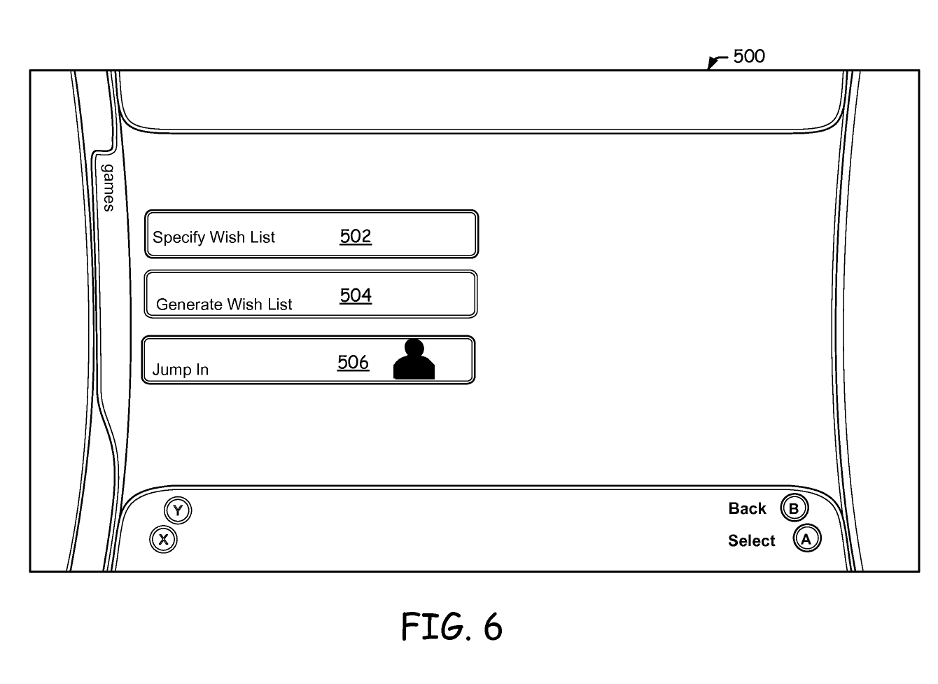

In an embodiment, processing devices 300A-X may also invoke a user wish list service 305 and a user matching list service 306 in the multiplayer network service 302. The user wish list service 305 enables users on processing devices 300A-X to specify participation in an activity based on user intent. Specifically, users on processing devices 300A-X may invoke the user wish list service 305 via a user interface on the processing devices 300A-X as will be discussed in greater detail in FIGS. 6-9. The user wish list service 305 receives a wish list of intents from the users on processing devices 300A-X and stores the wish list of intents associated with each of the users in the service database 312.

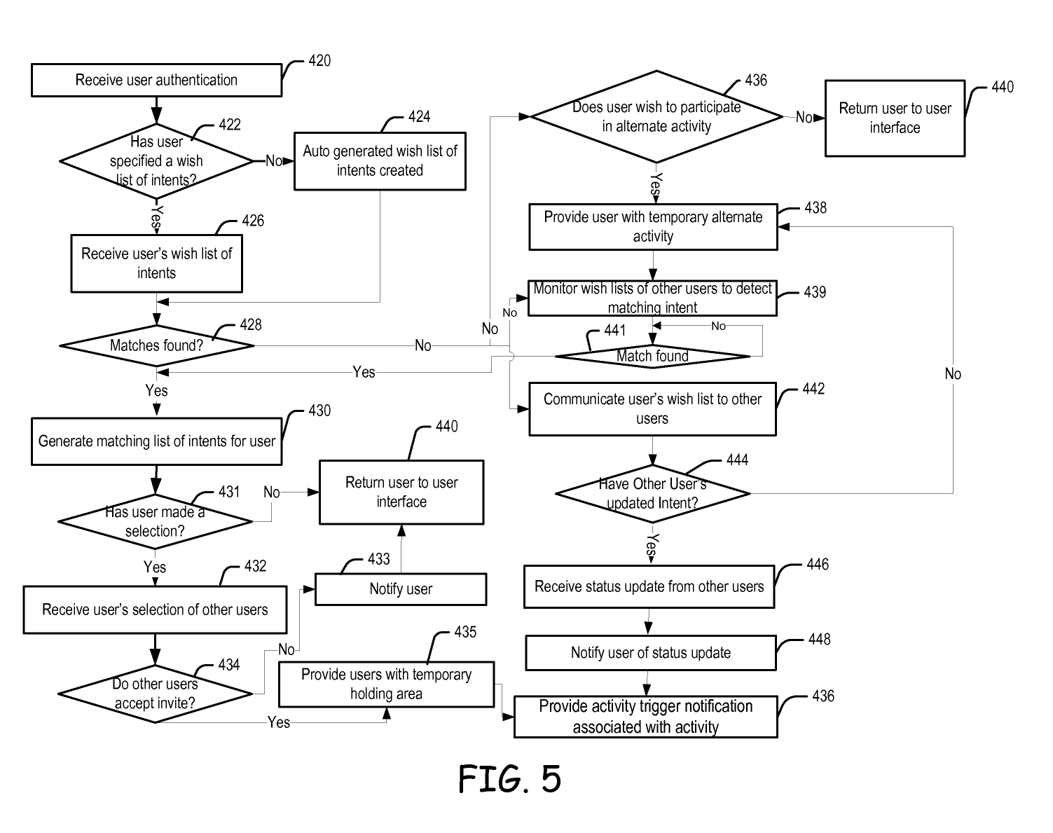

The user matching list service 306 receives the wish list of intents associated with each user from the user wish list service 305 and generates a matching list of intents for the users. The matching list of intents displays, to each user, a list of other users who also list an intent to participate in at least one of the activities specified by the user in the user's wish list of intents. The user matching list service 306 may receive a selection of the other users from the matching list of intents, from the user. The user matching list service 306 may then provide an activity trigger notification associated with the activity to the user and the other users. Specifically, users on processing devices 300A-X may invoke the user matching list service 306 via a user interface on the processing devices 300A-X as will be discussed in greater detail in FIGS. 6-9. The user wish list service 305 and the user matching list service 306 may be implemented as software modules that include executable instructions to perform the operations of the disclosed technology. The operations performed by the user wish list service 305 and the user matching list service 306 are discussed in greater detail with respect to FIG. 5 below.

User account records 310 can include additional information about the user such as game records 314 and friends list 316. Game records 314 include information for users identified by gamer tags and can include statistics for particular games, achievements acquired for particular games and/or other game specific information.

The friends list 314 includes an indication of friends of a user that are also connected to or otherwise have user account records with multiplayer gaming service 302. The term “friend” as used herein can broadly refer to a relationship between a user and another gamer, where the user has requested that the other gamer consent to be added to the user's friends list and the other gamer has accepted. This may be referred to as a two-way acceptance. A two-way friend acceptance may also be created where another gamer requests the user be added to the other gamer's friends list and the user accepts. At this point, the other gamer may also be added to the user's friends list. While friends will typically result from a two-way acceptance, it is conceivable that another gamer be added to a user's friends list, and be considered a “friend,” where the user has designated another gamer as a friend regardless of whether the other gamer accepts. It is also conceivable that another gamer will be added to a user's friends list, and be considered a “friend,” where the other user has requested to be added to the user's friends list, or where the user has requested to be added to the other gamer's friends list, regardless of whether the user or other gamer accepts in either case. In an embodiment, a user's friends list 316 may include the user's family, the user's friends, friends of the user's friends and all users connected to the multiplayer network service 302.

User account records 310 also include additional information about the user including games that have been downloaded by the user and licensing packages that have been issued for those downloaded games, including the permissions associated with each licensing package. Portions of user account records 310 can be stored on an individual processing device, in database 312 or on both. If an individual processing device retains game records 314 and/or friends list 316, this information can be provided to the multiplayer network service 302 through network 306. Additionally, the individual processing devices have the ability to display information associated with game records 314 and/or friends list 316 without having a connection to multiplayer network service 302.

The server(s) 304 in the multiplayer network service 302 also includes a message service 320 which permits one processing device, such as processing device 300A, to send a message to another processing device, such as processing device 300B. Messages may also be sent to an online message board and utilized by one or more applications, such as an email application executing in the user's processing device, or via Facebook®. The message service 320 is known, the ability to compose and send messages from a processing device is known, and the ability to receive and open messages at a processing device of a recipient is known. Mail messages can include emails, text messages, voice messages, attachments and specialized in-text messages known as invites, in which a user executing an application on one processing device invites a user on another processing device to participate in a multiplayer activity while using network 306 to pass data between the two processing devices so that the two users are playing from the same session of the multiplayer activity. Friends list 316 can also be used in conjunction with message service 320.

In accordance with the technology, the network service provider 350 allows a multitude of users on processing devices 300A-300X to participate in a multiplayer activity based on user intent. The group may be as small as two users and may include hundreds of thousands of users. The network service provider 350 obtains data and state information from the multiplayer network service 302, which it uses to provide information to users on processing devices 300A-X. It will be understood that the network service provider 350 and the multiplayer network service 302 may be integrated into a single service and/or a single server. Alternatively, the network service provider 350 may not be managed by the same administrator of the multiplayer network service 302 or different administrators.

Also shown in FIG. 3 with respect to the network service provider 350 are status services 322 and activity management services 330. The status services 322 collect user statistics and may track which friends of a particular user on one of the processing devices 300A-300X are participating or scheduled to participate in an online activity. Activity management services 330 may provide organization of the program content, breaking down the content into different sections, episodes, organizing the content into different channels, and ensuring that localized content is directed to the proper processing device and user.

Also included in the network service provider 350 are a scheduling database 324 and a library of applications 313. The library of applications 313 may comprise instructions executed on each of the processing devices to allow one or more users interacting with the processing devices to participate in a multiplayer activity. The schedule database 324 can be used to provide status services to each processing device to indicate which of the user's particular friends might be participating in an activity.

Processing device 300X illustrates functional components which may be present on each of the processing devices 300A-300X. Each processing device 300A-300X may be of a type such as that illustrated in FIGS. 1 and 2, wherein the functional components may comprise one or more sets of instructions or applications instructing the processor 200 to perform the functions described herein. Such functional components may be implemented in hardware, software or a combination of hardware or software. Moreover, the instructions may be embodied in a computer readable medium. A computer readable medium may include volatile and nonvolatile, removable and non-removable media implemented in any method or technology for storage of information such as computer readable instructions, data structures, program modules or other data. Computer readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by processing devices 300A-300X.

Processing device 300X (as well as processing devices 300A-300N) may include one or more applications 360a, 360b. The applications may include, for example, video game applications, internet browser applications and so forth. The applications may be delivered via a download from the applications data store 313, may be present in non-volatile memory such as Flash ROM memory 204 in the processing device, or may be provided on a computer storage medium such as a CD ROM, or other disk. The processing device 300X also includes a programmatic content engine 380 that may include parental control functionality, reminder functionality, and friend or game status updates. The programmatic content engine 380 may also provide a set of foundational components such as libraries, methods, tools and data which are re-usable by programmatic content games running on the processing device. When applications are executed on the processing device, new events 355 occur when a user provides input to the application, or as a result of another user's input to the application being returned to the processing device. Events caused by user activity on the processing device 300X are transmitted to the multiplayer network service 302 which manages multiplayer activities.

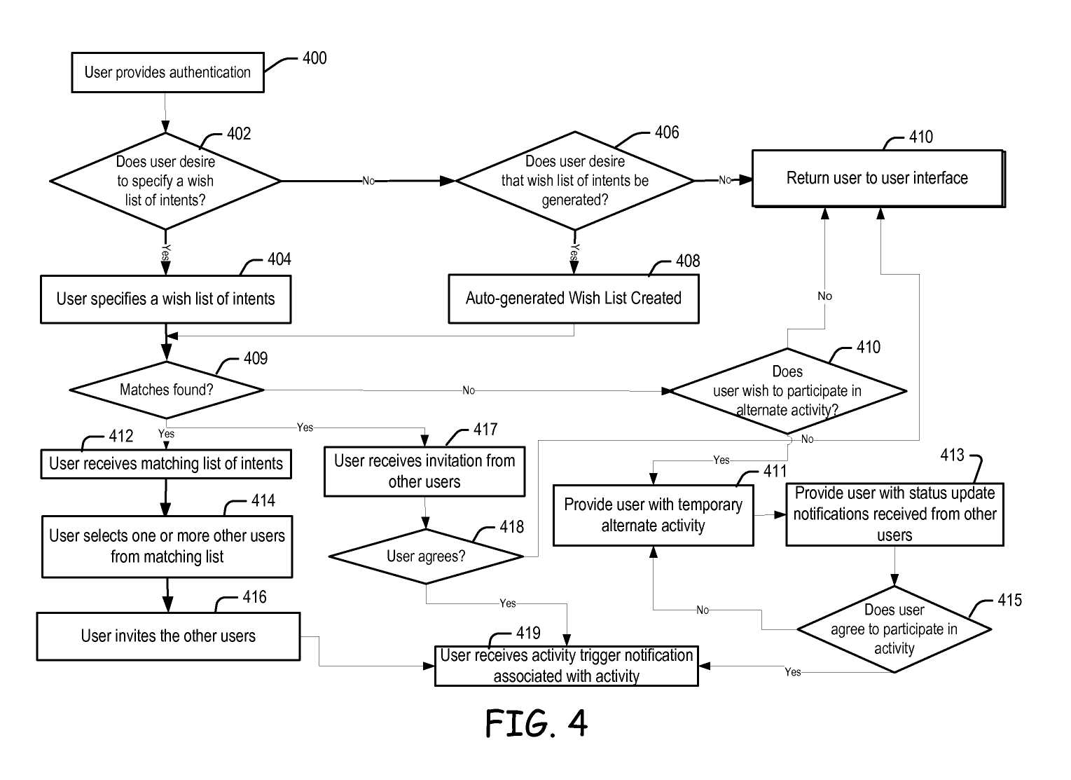

FIG. 4 illustrates an exemplary set of operations performed by the disclosed technology to enable a user to participate in an activity based on user intent. In one embodiment, the steps of FIG. 4 may be performed on a user's processing device. In step 400, a user provides authentication on a processing device, such as, for example, 300X shown in FIG. 3. Authentication may be performed locally on the processing device or by transmitting user authentication credentials to the multiplayer network service 302. Once the user is authenticated, at step 402, a check is made to determine if the user desires to specify a wish list of intents. The wish list of intents identifies user intent to participate in one or more activities in the processing device. At step 402, the user may be prompted by a user interface in the user's processing device to specify a wish list of intents. The user may also specify a wish list of intents via a variety of applications such as an email application executing in the user's processing device or via Facebook®. FIG. 6 illustrates an exemplary user interface screen that enables a user to specify a wish list of intents. At step 404, the user specifies a wish list of intents via the user interface. If at step 402, the user does not desire to specify a wish list of intents, then at step 406 a determination is made as to whether the user desires to have a wish list of intents be automatically generated. For example, if the user indicates no desire to input a wish list, the user may be prompted to indicate whether the user wishes to have the list automatically generated. In one embodiment, a wish list of intents is automatically generated for the user. The wish list of intents, either automatically generated or specified by the user may also include an activity that the user is currently engaged in (say, for example, the user activated the Jump In” option 506 as discussed in FIG. 6 because no other users were available to participate in any activities in the user's wish list) as an implied intent in the user's wish list of intents. The user may be notified as discussed below, when any user (such as, for example, the user's friends, friends of the user's friends or all users connected to the multiplayer network service 302) becomes available to participate in the activity with the user.

Auto generation of a wish list may occur on the user's processing device or on the multiplayer network service 302 (at step 424 below). If step 406 is true, then the user receives an automatically generated wish list of intents in step 408. A process for automatically generating a wish list of intents, based, for example, on the user's historical information, is disclosed in FIG. 5 below. FIG. 6 illustrates an exemplary user interface screen that enables the user to view an automatically generated wish list of intents. In an embodiment, a user's wish list of intents may also be published across various applications, such as an email application executing in the user's processing device, or via Facebook®. Accordingly, the disclosed technology may enable a user to specify a wish list of intents or view other users' wish list of intents even when the user is not actively participating in an activity on a processing device. If at step 406, the user does not desire that a wish list of intents be generated, then step 410 is performed to return the user to a user interface in the processing device. In an embodiment, upon returning to the user interface, the user may also activate the “Jump In” option 506 as discussed in FIG. 6 to participate in any activity executing in the processing device. As discussed below, once the user provides a wish list of intents, either by specifying one or having one automatically generated, the list can be used to match the user with other users who have specified the same intents. Other users may include, for example, one or more users in the user's friends list 316 such as the user's family, the user's friends, friends of the user's friends or all users connected to the multiplayer network service 302, in one embodiment. Once a user has specified a wish list of intents, the user specified wish list is provided to the multiplayer network service 302 to allow matching to occur. In an embodiment, the user matching list service 306 generates a matching list of intents for the user as discussed in FIG. 5 below.

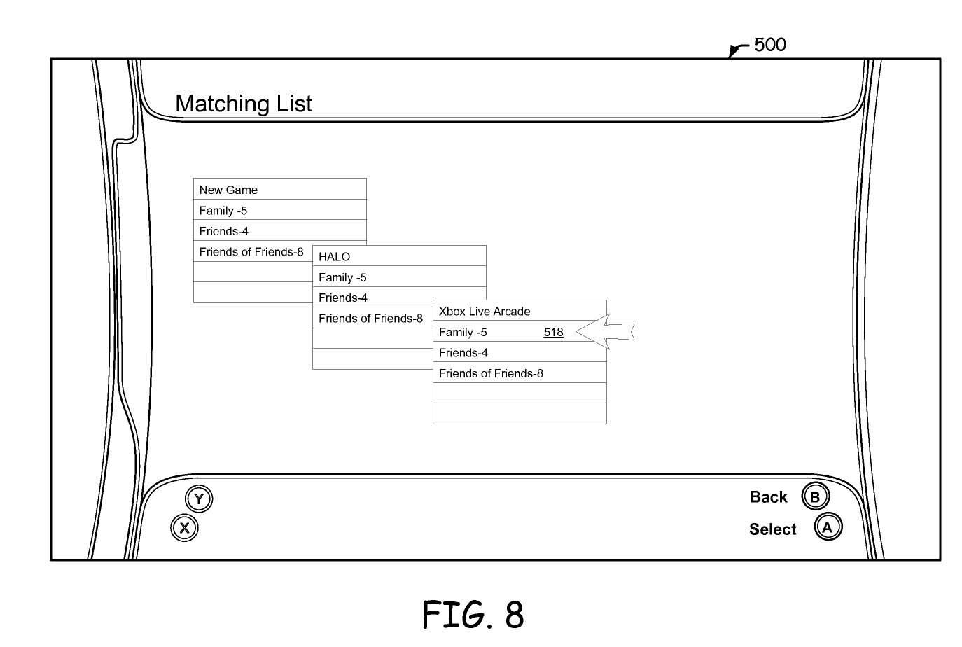

In step 409, if it is determined that matches are found, then in step 412, the user receives a matching list of intents once, for example, the user matching list service 306 has generated a matching list. The matching list of intents includes activities identified by other users that match at least one activity specified by the user in the user's wish list of intents. As mentioned above, other users may include, for example, one or more users in the user's friends list 316. FIG. 8 illustrates an exemplary user interface screen displaying a matching list of intents for the user. In step 414, the user selects one or more of the other users from the matching list of intents. In an embodiment, the user selects one or more other users via a user interface on the processing device. FIG. 8 illustrates an exemplary user interface screen that enables a user to select one or more other users from the matching list of intents. In step 416, the other users may be invited to participate in the activity. Invitations may be provided automatically based on the user selection in the matching list or by the user specifying invitations directly. For example, in one embodiment, a user may specify invitations directly to one or more other users by viewing the wish list of intents of other users such as, for example the user's friends, upon authentication to the processing device. For example, a user may view a wish list of intents that specifies an activity such as, “I would like to play HALO with my friends now”, upon authentication to the processing device. If the user also wishes to participate in the particular activity (e.g., HALO), but sees that the other users are not currently participating in the activity, the user may specify invitations directly to the other users to participate in the activity, even if the user has not yet specified intent to participate in the particular activity (e.g., HALO) in a wish list of intents.

In an embodiment, the user may invite the other users via a user interface on the processing device. Alternatively, the user may also invite users to participate in an activity via any application executing in the user's processing device, such as, an email application or via Facebook®.

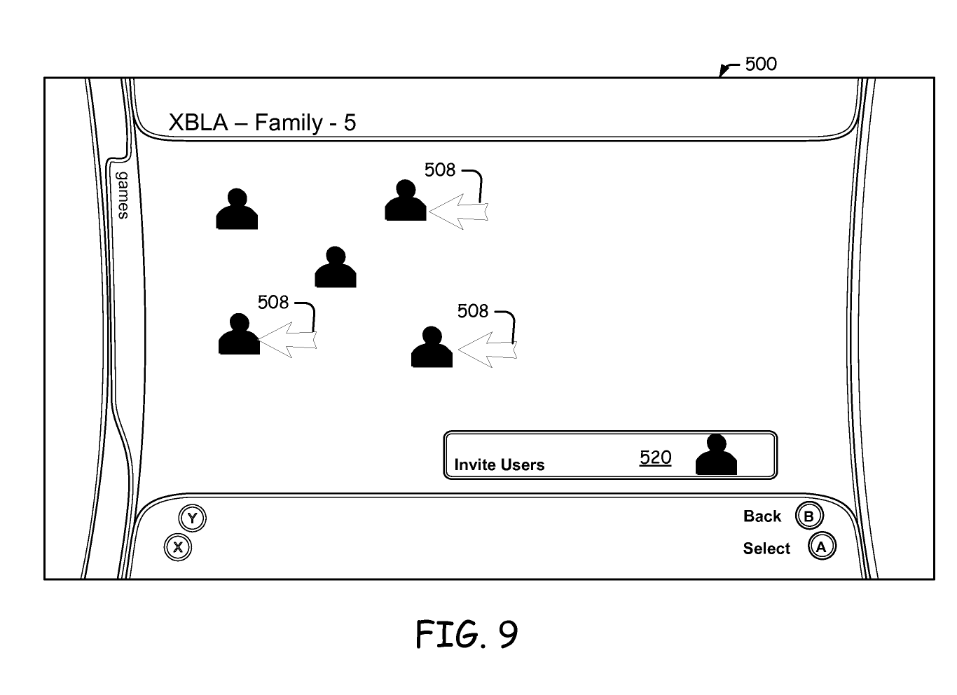

FIG. 9 illustrates an exemplary user interface screen that enables a user to invite the other users. Once the other users have agreed to participate in the activity, in step 419, the user and the other users are provided with an activity trigger notification associated with the activity. In one embodiment, the activity trigger notification may trigger the activity for the user and the other users instantly. For example, if the user's wish list of intents specified an activity such as, “I would like to play HALO with my friends now” and if the user matching list service 306 in the network gaming service 302 determines that one or more other users who agreed to participate in the activity are currently online and available to participate in the activity, the activity trigger notification provided to the user and the other users may indicate a commencement of the activity for the user and the other users instantly. Alternatively, if none of the other users are currently online, the activity trigger notification may commence the activity for the user and the other users as soon as one or more of the other users come online, by, for example, sending an alert or a note to the user that one or more of the other users are available to participate in the activity. Or, for example, if the user sees that another user, who is currently offline has specified an activity such as, “I wish to play Halo on Friday night”, and the user wishes to participate in the particular activity, an activity trigger notification may be sent to the user to commence the activity for the user as soon as the other user is online by sending a note or an alert to the user.

In another embodiment, the activity trigger notification associated with the activity may trigger the activity for the user and the other users at a pre-determined time. For example, if the user's wish list of intents specified an activity such as, “I wish to play HALO with my friends on Friday night” and the user matching list service 306 in the network gaming service 302 determines that all the other users have agreed to participate in the activity, then the activity trigger notification provided to the user and the other users may indicate a commencement of the activity for the user and the other users at the pre-determined point in time.

Alternatively, the activity trigger notification associated with the activity may automatically trigger the activity for the user and the other users when certain threshold criteria are met. For example, the activity may be automatically triggered for the user when a specified number of users become available to participate in the activity. Or, the activity trigger notification associated with the activity may include automatically triggering the activity for the user when certain location criteria are met, such as, when a particular user at a particular location becomes available to participate in the activity.

Steps 414 and 416 discussed above provide the user with the ability to select and invite other users from a matching list of intents to participate in a multiplayer game with the other users. In another embodiment, the user may also be automatically placed in an activity with one or more other users once a match is found as discussed in step 409 above.

In another embodiment, where matches are found at 409, a user may also receive an invitation from one or more other users to participate in an activity as illustrated in step 417. In an embodiment, a user may receive an invitation to participate in an activity on a user interface on the user's processing device. In another embodiment, a user may also receive an invitation to participate in an activity via any application executing in the user's processing device, such as, an email application or via Facebook®. In step 418, a check is made to determine if the user desires to accept the invitation from the other users. If the user desires to accept the invitation, the user may receive an activity trigger notification of the commencement of the activity as discussed in step 419. If the user does not desire to participate in the multiplayer activity with the other users, the user may be returned to a user interface on the user's processing device as discussed in step 410. The user may also be automatically placed in an activity with one or more other users who have specified intent to participate in an activity specified in the user's wish list of intents, in an alternate embodiment. That is, steps 412, 414, 416, 417, and 418 are performed automatically once a match between user intents is found.

If it is determined in step 409 that a matching list of intents does not exist, then at step 410, the user may be prompted to determine if the user desires to participate in an alternate activity. If the user desires to participate in an alternate activity, then the user is provided with an alternate activity in step 411. The process of specifying alternate activities for a user is discussed in step 436 in FIG. 5. If the user does not wish to participate in an alternate activity, then step 410 is performed to return the user to a user interface on the user's processing device. While the user is engaged in the alternate activity in step 411, a user may also be provided with status update notifications from other users on one or more of the processing devices 300A-300X or via one or more applications executing on one or more of the processing devices 300A-300X in step 413 indicating intent to participate in a multiplayer activity specified in the user's wish list of intents. The process of receiving status update notifications from other users is discussed in step 448 in FIG. 5. In step 415, if it is determined that the user still desires to participate in the activity with the other users, then an activity trigger notification of the commencement of the activity is sent to the user in step 419 as discussed above. If the user does not desire to participate in the activity with the other users, then the user may continue to be engaged in the alternate activity as discussed in step 411. In an alternate embodiment, the user may also be automatically placed in an activity with one or more other users who have provided a status update indicating intent to participate in any activity specified in the user's wish list of intents.

FIG. 5 illustrates an exemplary set of operations performed by the multimedia network service 302 shown in FIG. 3 to enable a user to participate in an activity based on user intent. In step 420, a user's authentication is received via the user login service 308 in the multiplayer network service 302. In order to participate with other users, the user identity must be verified. As noted above, this may be performed at the user's processing device or at the service level. In step 422, a check is made to determine if a wish list of intents has been specified by the user. A wish list of intents may be specified by the user as discussed is step 404 in FIG. 4 above and via the user interface illustrated in FIG. 6. If the user has specified a wish list of intents, (or if the wish list of intents has been automatically generated) then the user's wish list of intents is received in step 426. If the user has not specified a wish list of intents, then a wish list of intents may be automatically generated for the user by the wish list service in step 424 if the user has provided an indication in step 406 that the user wishes to have a wish list automatically generated. The user wish list service 305 may generate a wish list of intents for the user based on analyzing information about the user stored in the service database 320 in the multiplayer network service 302. The information may include, for example, the user's stored/past wish lists of intents, previous games played by the user, the user's age, the user's location, the user's residence and games preordered by the user. Based on this information, a wish list of intents may be generated for the user.

In step 428, a check is made to determine if any matches between the user's wish list or the automatically generated wish list, and other users' wish lists are found. If matches are found, then a matching list of intents is generated for the user in step 430. In an embodiment, the user matching list service 306 generates the matching list of intents for the user. As noted above, the matching list of intents may be provided to the user to allow the user to select to participate in a desired activity, such as one or more multiplayer online games specified by other users that match at least one of the intents specified in the user's wish list of intents. In step 431, a check is made to determine if the user has selected to participate in an activity in the matching list. If the user has not selected to participate in any activity in the matching list, the user is returned to the user interface in step 440. If the user has selected to participate in an activity in the matching list, then the user's selection of other users from the matching list and the invitation to the selected users to participate in the mutually identified activity is received from the user in step 432. As discussed above, the invitation may be generated automatically or directly as specified by the user, and transmitted to the invited users at their respective processing devices. In step 434, a check is made to determine if the other users selected by the user desire to accept the user's invitation to participate in the activity. If the other users accept the user's invitation, then an activity trigger notification associated with the activity is provided to the user and the other users in step 436. If the other users do not desire to accept the user's invitation in step 434, then the user is notified in step 433 and returned to a user interface as discussed in step 440. Alternatively, the user may also be automatically placed in an activity with one or more of the other users once a match is found as discussed in step 428 above.

In accordance with the disclosed technology, the users may be provided with a temporary holding area in step 435 before an activity is activated for the user and the other users in step 436. For example, there may be some users who are currently engaged in another activity when they receive an invitation from the user. The temporary holding area provides users with an alternate activity until all the users can get together to participate in the multiplayer game specified in the user's wish list of intents. In another embodiment, the temporary holding area may also provide users with a communication channel to communicate with each other prior to the commencement of an activity.

At step 428, if no matches are found, that is, if no other users are available to participate in any activity specified in the user's wish list of intents, the user may be prompted to determine if the user wishes to participate in an alternate activity in step 436. If the user wishes to participate in an alternate activity, the user is provided with an alternate activity in step 438. An alternate activity may include providing the user with an instantly available experience such as streaming a movie of the user's choice to the user or allowing the user to participate in any scheduled program executing in the user's processing device. An alternate game related activity may also include providing the user with a communication channel to communicate with other users prior to the commencement of an activity. If the user does not wish to participate in an alternate activity, then the user is returned to a user interface on the user's processing device at step 440.

In an embodiment, when no matches are found as discussed in step 428, the wish list of intents specified by other users on one or more of the processing devices 300A-300X may be continuously monitored to detect a matching intent in step 439. For example, other users on one or more of the processing devices 300A-300X may decide to update their wish list of intents as discussed in step 446 below. Or, for example, another user, such as a new user on a processing device and specify a wish list of intents. In step 441, a check is made to determine if any matches are found. If a match is found, then an updated matching list of intents is generated for the user as discussed in step 430. In an embodiment, the user matching list service 306 monitors the wish list of intents of all the users on one or more of the processing devices 300A-300X and automatically updates the user's matching list of intents when a matching intent is detected.

In another embodiment, when no matches are found as discussed in step 428, the user's wish list of intents (either specified by the user or automatically generated as discussed above) may also be communicated to one or more other users on one or more of the processing devices 300A-300X in step 442. In an embodiment, the user matching list service 306 communicates the user's wish list to one or more other users on one or more of the processing devices 300A-300X. The wish list of intents that is communicated to the other users may include recently pre-ordered or purchased games by the user, or games that have not yet been purchased by the user. For example, a user may preorder or purchase a game via the Xbox Live® Marketplace (XBLM) in the Xbox Live® online game service. A recently pre-ordered or purchased game by the user may be indicative of the user's intent to participate in the game in the near future.

In step 444, a check is made to determine if the other users have updated their intent to participate in any activity. If one or more of the other users have updated their intent, then a status update, via a text message or a voice input may be received from one or more of the other users to indicate intent to participate in an activity specified in the user's wish list of intents in step 446. In step 448, the user is notified of the status update of the intent of the other users. In step 448, a notification message of the status update of intent of the other users may be sent to the user and the user's matching list of intents may be automatically updated to include the intent of the other users. In an embodiment, the notification message of the status update of intent of the other users may be displayed on a user interface in the user's processing device. In another embodiment, the notification message of the status update of intent of the other users may also be displayed on one or more applications such as the user's email application executing in the user's processing device or via Facebook®.

If no other users on one or more of the processing devices 300A-300X wish to update their intent in step 444, then the user continues to be engaged in the alternate activity until one or more other users become available or the user may be notified as discussed in step 433 and returned to a user interface as discussed in step 440. In step 436, an activity trigger notification associated with the activity is provided to the user and the other users, as discussed above. In an embodiment, the other users may be provided with a temporary holding area as discussed in step 435 before the activity is activated for the users.

It is to be appreciated that the operations (420-448) in FIG. 5 may be performed by executable instructions in the user wish list service 305 and the user matching list service 306 in the multiplayer gaming service 302, in one embodiment. In alternative embodiments, the operations may also be performed by alternative processors such as processor 200 in a processing device as illustrated in FIG. 2 or by processing unit 259 in computer 241 as illustrated in FIG. 2A.

FIG. 6 illustrates an exemplary user interface screen for enabling a user to specify a wish list of intents to participate in an activity. Interface elements 502, 504 and 506 are user selectable buttons in a user interface 500 which may be selected by a user highlighting one of the visual elements 502-506 responsive to positioning instructions received from the controller 104. The “Set Wish List” option 502 enables a user to specify a wish list of intents. A wish list of intents identifies user intent to participate in one or more activities. A user's wish list may also identify user intent to participate in a specific activity with specific users. For example, a user may wish to participate in a particular activity, such as a multiplayer game with the user's family.

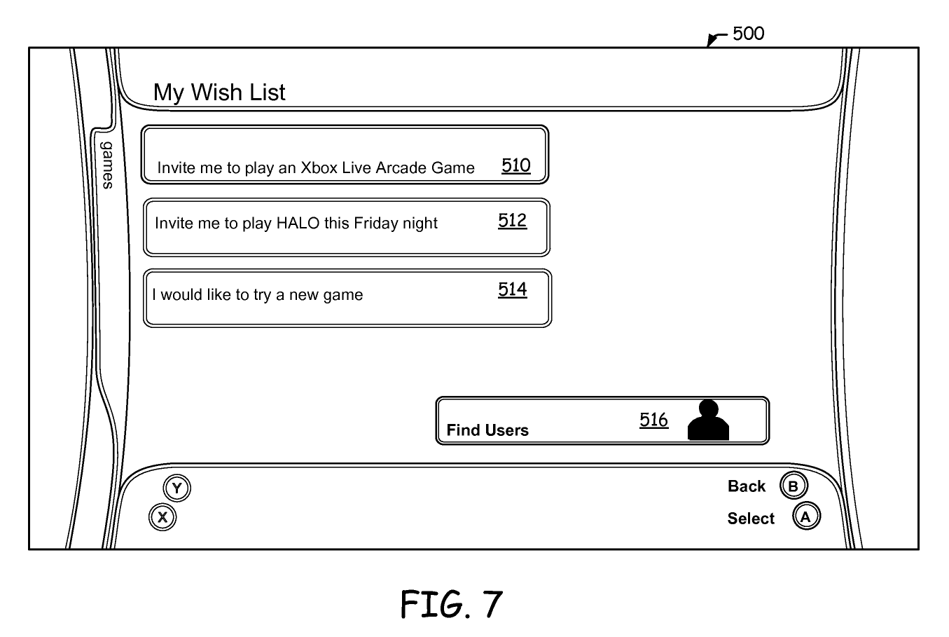

An exemplary wish list of intents is illustrated in FIG. 7. The “Generate Wish List” option 504 enables the user to view an automatically generated wish list of intents. The “Jump In” option 506 activates an activity for the user in the user's wish list of intents. In an embodiment, the user may activate the “Jump In” option 506 to participate in any scheduled game or activity executing in the processing device if the user does not wish to specify a wish list of intents using the “Specify Wish List” option 502 or if the user does not wish that a wish list of intents be generated via the “Generate Wish List” option 504. In an alternate embodiment, the “Jump In” option 506 may also be automatically activated for the user to provide the user with an alternate activity such as described in step 436 FIG. 5 until one or more users become available to participate in any one of activities specified by the user in the wish list of intents.

FIG. 7 illustrates an exemplary user interface screen that displays a user's wish list of intents. As discussed above, a wish list of intents may be specified by the user when the user activates the “Set Wish List” option 502 or the user may view an automatically generated wish list of intents when the user activates the “Generate Wish List” option 504. As illustrated, an exemplary wish list of intents may include a first intent “Invite me to play an Xbox Live® Arcade Game” 510, a second intent, “Invite me to play HALO this Friday night” 512 and a third intent “I would like to try a new game” 514. A user's wish list of intents may also identify intent from the user to interact with specific users. For example, a user's wish list may identify intent such as, “Invite me to play HALO with my friends”. A user may select the “Find Users” option 516. Activating the “Find Users” option 516 displays a matching list of intents for the user as illustrated in FIG. 8.

FIG. 8 illustrates an exemplary user interface screen that displays a user's matching list of intents. The matching list of intents displays to the user, one or more other users who intend to participate in at least one activity specified by the user in the user's wish list of intents. In an embodiment, the matching list of intents aggregates the user's wish list of intents across various users in the user's friends list 316. A user may select to participate in an activity with specific users. In the illustrated example, the user selects to play an Xbox Live® Arcade game with his family by selecting the “Family-5” option 518. The “Family-5” option indicates that five users from the user's family wish to participate in the online multiplayer game. Upon activation of the “Family-5” option 518, the user may be presented with a user interface screen as illustrated in FIG. 9 to invite the other users to participate in the activity.

FIG. 9 is an exemplary user interface screen that allows a user to invite other users to participate in an activity based on user intent. As illustrated, the user may select one or more other users 508 and then activate the “Invite Users” option 520 to invite the other users to participate in the activity. Upon activation of the “Invite Users” option 520, the user may start participating in the activity with the other users.

As noted above, the present technology may be utilized across different processing platforms. The technology may likewise be utilized with different types of controller systems. The system may provide the interfaces utilized above with respect to the selection of intents, or may provide alternative interfaces suited to a target recognition and tracking system as discussed below.

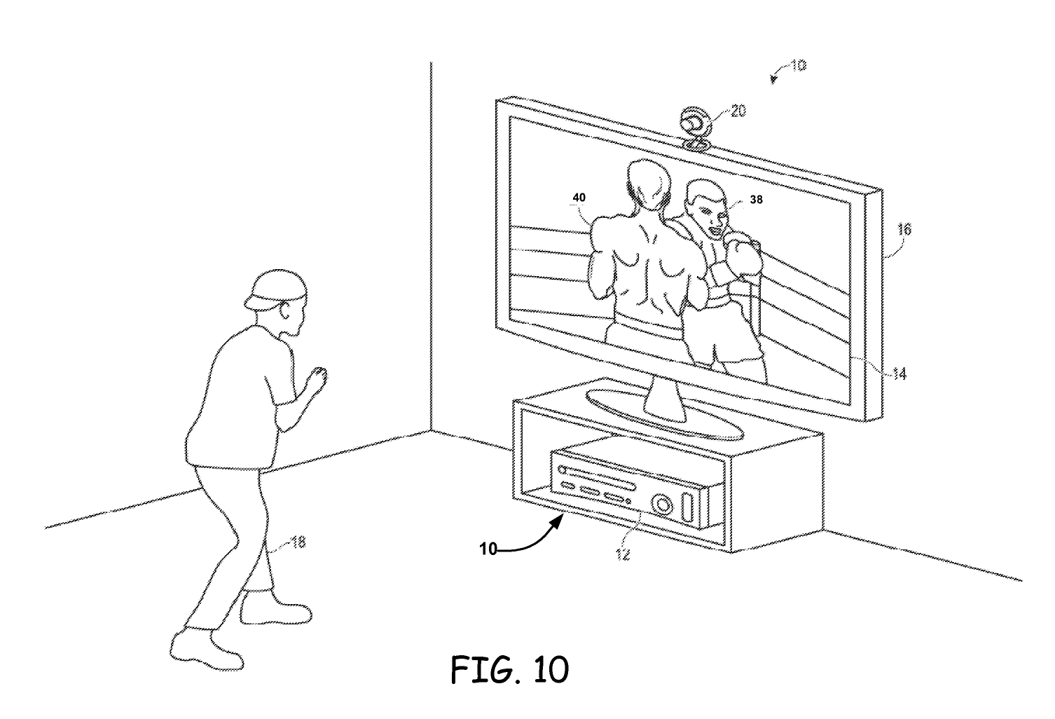

FIGS. 10-12 illustrate a target recognition and analysis system as an exemplary processing device for implementing the operations of the disclosed technology. FIGS. 10-12 illustrate a target recognition, analysis, and tracking system 10 which may be used by the disclosed technology to recognize, analyze, and/or track a human target such as a user 18. Embodiments of the target recognition, analysis, and tracking system 10 include a computing environment 12 for executing a gaming or other application, and an audiovisual device 16 for providing audio and visual representations from the gaming or other application. The system 10 further includes a capture device 20 for detecting gestures of a user captured by the device 20, which the computing environment receives and uses to control the gaming or other application. Each of these components is explained in greater detail below.

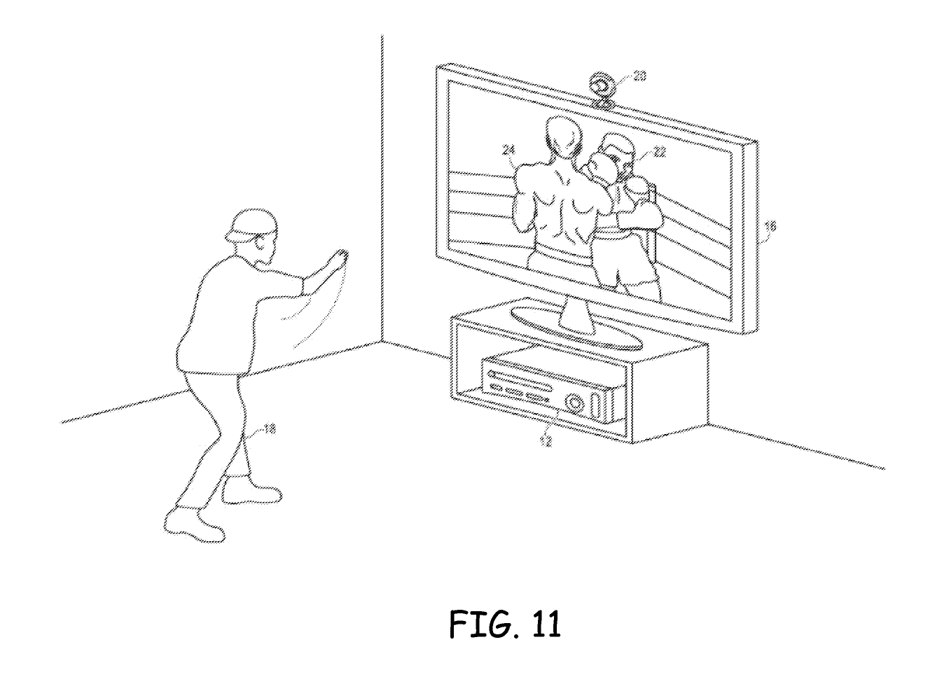

As shown in FIGS. 10 and 11, in an example embodiment, the application executing on the computing environment 12 may be a boxing game that the user 18 may be playing. For example, the computing environment 12 may use the audiovisual device 16 to provide a visual representation of a boxing opponent 22 to the user 18. The computing environment 12 may also use the audiovisual device 16 to provide a visual representation of a player avatar 24 that the user 18 may control with his or her movements. For example, as shown in FIG. 11, the user 18 may throw a punch in physical space to cause the player avatar 24 to throw a punch in game space. Thus, according to an example embodiment, the computer environment 12 and the capture device 20 of the target recognition, analysis, and tracking system 10 may be used to recognize and analyze the punch of the user 18 in physical space such that the punch may be interpreted as a game control of the player avatar 24 in game space.

Other movements by the user 18 may also be interpreted as other controls or actions, such as controls to bob, weave, shuffle, block, jab, or throw a variety of different power punches. Moreover, as explained below, once the system determines that a gesture is one of a punch, bob, weave, shuffle, block, etc., additional qualitative aspects of the gesture in physical space may be determined. These qualitative aspects can affect how the gesture (or other audio or visual features) are shown in the game space as explained hereinafter.

In example embodiments, the human target such as the user 18 may have an object. In such embodiments, the user of an electronic game may be holding the object such that the motions of the player and the object may be used to adjust and/or control parameters of the game. For example, the motion of a player holding a racket may be tracked and utilized for controlling an on-screen racket in an electronic sports game. In another example embodiment, the motion of a player holding an object may be tracked and utilized for controlling an on-screen weapon in an electronic combat game.

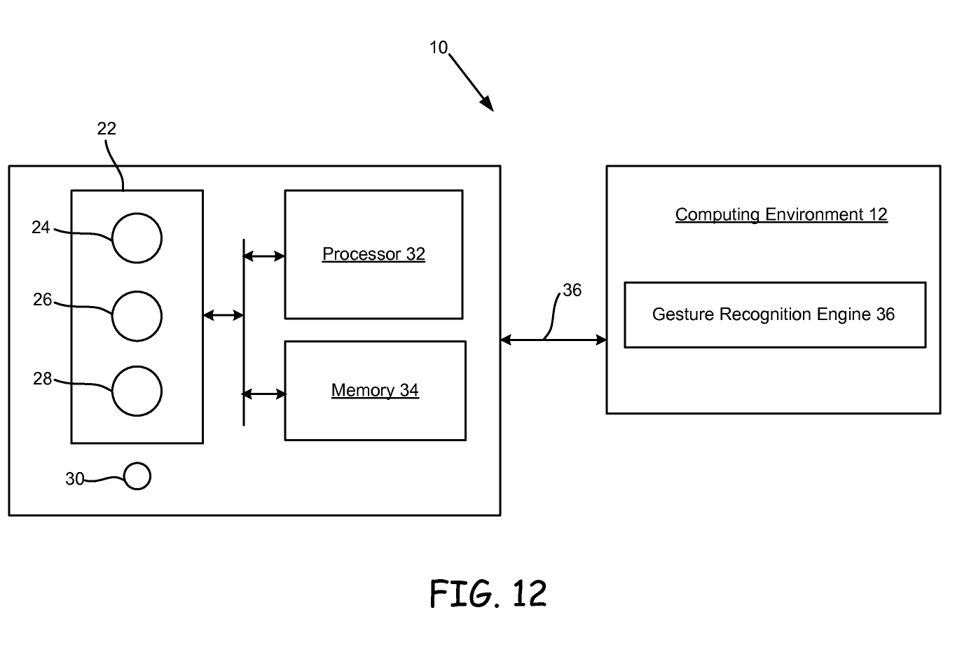

FIG. 12 illustrates an example embodiment of the capture device 20 that may be used in the target recognition, analysis, and tracking system 10. According to an example embodiment, the capture device 20 may be configured to capture video with depth information including a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z axis extending from the depth camera along its line of sight.

As shown in FIG. 12, the capture device 20 may include an image camera component 22. According to an example embodiment, the image camera component 22 may be a depth camera that may capture the depth image of a scene. The depth image may include a two-dimensional (2-D) pixel area of the captured scene where each pixel in the 2-D pixel area may represent a length in, for example, centimeters, millimeters, or the like of an object in the captured scene from the camera.

As shown in FIG. 12, according to an example embodiment, the image camera component 22 may include an IR light component 24, a three-dimensional (3-D) camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging. According to another embodiment, the capture device 20 may include two or more physically separated cameras that may view a scene from different angles, to obtain visual stereo data that may be resolved to generate depth information.

The capture device 20 may further include a microphone 30. The microphone 30 may include a transducer or sensor that may receive and convert sound into an electrical signal. According to one embodiment, the microphone 30 may be used to reduce feedback between the capture device 20 and the computing environment 12 in the target recognition, analysis, and tracking system 10. Additionally, the microphone 30 may be used to receive audio signals that may also be provided by the user to control applications such as game applications, non-game applications, or the like that may be executed by the computing environment 12.

In an example embodiment, the capture device 20 may further include a processor 32 that may be in operative communication with the image camera component 22. The processor 32 may include a standardized processor, a specialized processor, a microprocessor, or the like that may execute instructions for receiving the depth image, determining whether a suitable target may be included in the depth image, converting the suitable target into a skeletal representation or model of the target, or any other suitable instruction.

The capture device 20 may further include a memory component 34 that may store the instructions that may be executed by the processor 32, images or frames of images captured by the 3-D camera or RGB camera, or any other suitable information, images, or the like. According to an example embodiment, the memory component 34 may include random access memory (RAM), read only memory (ROM), cache, Flash memory, a hard disk, or any other suitable storage component. As shown in FIG. 12, in one embodiment, the memory component 34 may be a separate component in communication with the image capture component 22 and the processor 32. According to another embodiment, the memory component 34 may be integrated into the processor 32 and/or the image capture component 22.

As shown in FIG. 12, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36. Additionally, the capture device 20 may provide the depth information and images captured by, for example, the 3-D camera 26 and/or the RGB camera 28, and a skeletal model that may be generated by the capture device 20 to the computing environment 12 via the communication link 36. The computing environment 12 may then use the skeletal model, depth information, and captured images to, for example, recognize user gestures and in response control an application such as a game or word processor.

For example, as shown, in FIG. 12, the computing environment 12 may include a gesture recognizer engine 36. The gesture recognition engine 36 may be implemented as a software module that includes executable instructions to perform the operations of the disclosed technology. The gesture recognizer engine 36 may include a collection of gesture filters, each comprising information concerning a gesture that may be performed by the skeletal model (as the user moves). The data captured by the cameras 26, 28 and device 20 in the form of the skeletal model and movements associated with it may be compared to the gesture filters in the gesture recognizer engine 36 to identify when a user (as represented by the skeletal model) has performed one or more gestures. Those gestures may be associated with various controls of an application. Thus, the computing environment 12 may use the gesture recognizer engine 36 to interpret movements of the skeletal model and to control an application based on the movements. In an embodiment, the computing environment 12 may receive gesture information from the capture device 20 and the gesture recognizer engine 36 may identify gestures and gesture styles from this information.

Further details relating to the gesture recognition engine for use with the present technology are set forth in copending patent application Ser. No. 12/642,589, filed Dec. 18, 2009, which is incorporated herein by reference in its entirety. More information about gestures can be found in the following patent applications that are incorporated by reference herein in their entirety. U.S. patent application Ser. No. 12/474,655, “Gesture Tool” filed on May 29, 2009, and hereby fully incorporated herein by reference; U.S. patent application Ser. No. 12/422,661, “Gesture Recognizer System Architecture,” filed on Apr. 13, 2009 and hereby fully incorporated herein by reference; U.S. patent application Ser. No. 12/391,150, “Standard Gestures,” filed on Feb. 23, 2009 and hereby fully incorporated herein by reference; U.S. patent application Ser. No. 12/475,208, “Gestures Beyond Skeletal,” filed on May 29, 2009; U.S. patent application Ser. No. 12/782,377, “Gestures and Gesture Recognition for Manipulating a User-Interface”, filed on May 18, 2010 and hereby fully incorporated herein by reference, U.S. patent application Ser. No. 12/782,380, “Gestures and Gesture Modifiers for Manipulating a User-Interface”, filed on May 18, 2010, and hereby fully incorporated herein by reference, U.S. patent application Ser. No. 12/641,788, “Motion Detection Using Depth Images,” filed on Dec. 18, 2009 and hereby fully incorporated herein by reference; and U.S. patent application Ser. No. 12/475,308, “Device for Identifying and Tracking Multiple Humans over Time,” filed on May 29, 2009 hereby fully incorporated herein by reference.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A computer implemented method for enabling a user to participate in an activity in a processing device based on user intent, the method comprising:
receiving a wish list of intents from a user on a processing device, wherein the wish list of intents identifies user intent to participate in one or more activities in the processing device;
generating a matching list of intents for the user, wherein the matching list of intents comprises at least one activity identified by other users that matches an intent in the wish list of intents specified by the user;
receiving a selection of one or more of the other users in the matching list of intents from the user; and
providing an activity trigger notification associated with the activity to the user and one or more of the other users based on the selection.

2. The computer implemented method of claim 1, wherein the activities comprise at least one of game related activities and non-game related activities in the processing device.

3. The computer implemented method of claim 2, wherein the game related activities comprise at least one of a single player game and a multiplayer game in the processing device.

4. The computer implemented method of claim 1, wherein the processing device comprises a gaming and media console, a personal computer and a mobile device.

5. The computer implemented method of claim 1 comprising generating a wish list of intents for the user based on at least one of a past wish list of intents associated with the user, previous activities associated with the user, age of the user and location of the user.

6. The computer implemented method of claim 1 comprising specifying a wish list of intents via at least one of a user interface on the processing device or via one or more applications executing on the processing device.

7. The computer implemented method of claim 1, wherein providing an activity trigger notification associated with the activity comprises triggering the activity for the user and the other users instantly.

8. The computer implemented method of claim 1, wherein providing an activity trigger notification associated with the activity comprises triggering the activity for the user and the other users at a pre-determined time.

9. The computer implemented method of claim 1 comprising:
communicating the wish list of intents associated with the user to the one or more other users via a user interface on one or more processing devices;
receiving a status update from the one or more other users via the user interface on the one or more processing devices, wherein the status update indicates user intent to participate in an activity in the wish list of intents specified by the user;
notifying the user of the status update associated with the one or more other users via the user interface on the one or more processing devices; and
updating the matching list of intents associated with the user based on the status update.

10. The computer implemented method of claim 1 comprising:
communicating the wish list of intents associated with the user to the one or more other users via one or more applications executing on one or more processing devices;
receiving a status update from the one or more other users via the one or more applications executing on the one or more processing devices, wherein the status update indicates user intent to participate in an activity in the wish list of intents specified by the user;
notifying the user of the status update associated with the one or more users via the one or more applications executing on the one or more processing devices; and
updating the matching list of intents associated with the user based on the status update.

11. A computer implemented method for enabling a user to participate in an activity in a processing device based on user intent, the method comprising:
receiving a wish list of intents from a user on a processing device, wherein the wish list of intents identifies user intent to participate in one or activities in the processing device;
communicating the wish list of intents to one or more other users in one or more processing devices;
receiving a status update from one or more of the other users on one or more of the processing devices, wherein the status update indicates user intent to participate in an activity in the wish list of intents specified by the user;
notifying the user of the status update associated with one or more of the other users on one or more of the processing devices; and
providing an activity trigger notification associated with the activity to the user and one or more of the other users on one or more of the processing devices based on the status update.

12. The computer implemented method of claim 11, wherein the processing device comprise a gaming and media console, a personal computer and a mobile device.

13. The computer implemented method of claim 11 comprising generating a matching list of intents for the user, wherein the matching list of intents comprises at least one activity identified by one or more of the other users that matches an intent in the wish list of intents specified by the user.

14. The computer implemented method of claim 13 comprising providing the user with an alternate activity if the intent of one or more of the other users does not match an intent in the wish list of intents specified by the user.

15. The computer implemented method of claim 14 wherein the alternate activity comprises at least one of streaming a movie to the user, providing a communication channel to enable the user to communicate with one or more of the other users or enabling the user to participate in a scheduled program executing in the processing device.

16. A system comprising:
a multiplayer gaming service in communication with a plurality of processing devices, wherein the multiplayer gaming service comprises a:
a user wish list service for receiving a wish list of intents from a plurality of users in the plurality of processing devices; and
a user matching list service for generating a matching list of intents for the plurality of users based on the wish list of intents, wherein the user matching list service provides an activity trigger notification associated with the activity to the plurality of users based on the matching list of intents.

17. The system of claim 16 wherein the wish list of intents identifies user intent to participate in one or more activities in the one or more processing devices.

18. The system of claim 16 comprising displaying the wish list of intents associated with the plurality of users via a user interface in the plurality of processing devices.

19. The system of claim 16 comprising displaying the matching list of intents associated with the plurality of users via a user interface in the plurality of processing devices

20. The system of claim 19 wherein the wish list of intents includes an activity that the user is currently engaged in as an implied intent in the wish list of intents.
